(19) United States
(12) Patent Application Publication
(10) Pub. No.: US 2012/0211521 A1
(43) Pub. Date: Aug. 23, 2012

(54) BABY FOOD PREPARATION APPARATUS

(75) Inventors: Sarah Moeggenberg, Northville, MI (US); Mordechai Lev, West Bloomfield, MI (US)

(73) Assignee: FKA DISTRIBUTING CO. D/B/A HOMEDICS, INC., Commerce Township, MI (US)

(21) Appl. No.: 13/403,631

(22) Filed: Feb. 23, 2012

Related U.S. Application Data
(60) Provisional application No. 61/445,615, filed on Feb. 23, 2011.

(51) Int. Cl. B67D 7/84

(52) U.S. Cl. 222/134

(57) ABSTRACT

A baby food preparation apparatus has a housing with a dispensing portion for dispensing dry baby food and water. A reservoir is located within the housing to hold dry baby food and dispense the dry baby food through the dispensing portion. A water tank is removably received within the housing to hold water and dispense the water through the dispensing portion. A user interface has a selector knob for selecting a desired serving size of prepared baby food, and selector buttons for selecting a type of baby food to be prepared. A processor is configured to dispense an amount of water corresponding to the type of baby food selected and the desired serving size.

### CROSS-REFERENCE TO RELATED APPLICATIONS

This application claims the benefit of U.S. provisional Application No. 61/445,615 filed Feb. 23, 2011, the disclosure of which is incorporated in its entirety by reference herein.

### TECHNICAL FIELD

Embodiments relate to a baby food preparation apparatus, such as for preparing baby formula and baby cereal from dry ingredients.

### BACKGROUND

Baby formula is a common substitute used to feed an infant in place of a mother's breast milk. However, unlike breast milk, formula takes time to prepare and care must be taken to ensure that the formula is at the proper temperature for consumption. Also, if the formula is a dry mixture, care needs to be taken to ensure that the formula is well mixed with the liquid. While formula dispensing and preparation units have been employed in an attempt to expedite the baby formula preparation process, many of these devices are either incomplete or overly complex, or result in clumping of formula that may cause malfunction of the device.

### SUMMARY

In an embodiment, a baby food preparation apparatus is provided with a housing having a dispensing portion for dispensing dry baby food and water. A reservoir is within the housing and is configured to hold dry baby food and dispense the dry baby food through the dispensing portion. A water tank is removably received within the housing and is configured to hold water and dispense the water through the dispensing portion. A user interface is provided on the housing. The user interface has a selector knob for selecting a desired serving size of prepared baby food, and selector buttons for selecting a type of baby food to be prepared. A processor is in communication with the user interface and is configured to dispense an amount of water corresponding to the type of baby food selected and the desired serving size.

In another embodiment, a baby food preparation apparatus is provided with a housing having a dispensing portion for dispensing dry baby food and water. A reservoir is within the housing and is configured to hold dry baby food and dispense the dry baby food through the dispensing portion. The reservoir includes a reservoir gear rotatably attached thereto and an agitator connected to the reservoir gear. A water tank is removably received within the housing and is configured to hold water and dispense the water through the dispensing portion. A generally cylindrical dispensing mechanism is removably received in the housing and extends at least partially through the reservoir. The dispensing mechanism has a selector knob at one thereof accessible by a user at a user interface of the housing for selecting a desired serving size of prepared baby food. The dispensing mechanism has a plurality of circumferentially extending blades spaced and sized to hold increments of dry baby food to be dispensed corresponding to the desired serving size. The dispensing mechanism has a first gear disposed thereon arranged to engage the reservoir gear such that rotation of the selector knob rotates the agitator to mix the dry baby food for dispensing. A processor is in communication with the user interface and configured to dispense an amount of water corresponding to the desired serving size.

In yet another embodiment, a baby food preparation apparatus is provided with a housing having a dispensing portion for dispensing dry baby food and water. The dispensing portion has an annular water pathway separate from and encircling a central dry food pathway. A reservoir is within the housing and is configured to hold dry baby food and dispense the dry baby food through the dry food pathway of the dispensing portion. A water tank is removably received within the housing and is configured to hold water and dispense the water through the water pathway of the dispensing portion. An adjustable platform is received on the housing for supporting a container at a designated height with respect to the dispensing portion. A user interface is provided on the housing and has a selector knob for selecting a desired serving size of prepared baby food. A processor is in communication with the user interface and is configured to dispense an amount of water corresponding to the desired serving size.

### BRIEF DESCRIPTION OF THE DRAWINGS

FIG. 1 is a perspective view of a baby food preparation apparatus according to an embodiment;

FIG. 2 is a partial perspective view of a removable water tank on a rear portion of the apparatus;

FIG. 3 is a perspective view of an adjustable platform on a front portion of the apparatus;

FIGS. 4a and 4b are perspective views of a magnetic platform and cooperating housing portion, respectively, according to one embodiment;

FIG. 5 is a cross-sectional view of an embodiment of the apparatus;

FIG. 6 is another cross-sectional view of an embodiment of the apparatus;

FIG. 7 is a perspective view of several internal components of an embodiment of the apparatus;

FIG. 8 is a perspective view of a dispensing portion and container aligning mechanism of an embodiment of the apparatus;

FIG. 9 is a perspective view of an embodiment of a dispensing mechanism; and

FIG. 10 is a perspective view of a reservoir according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

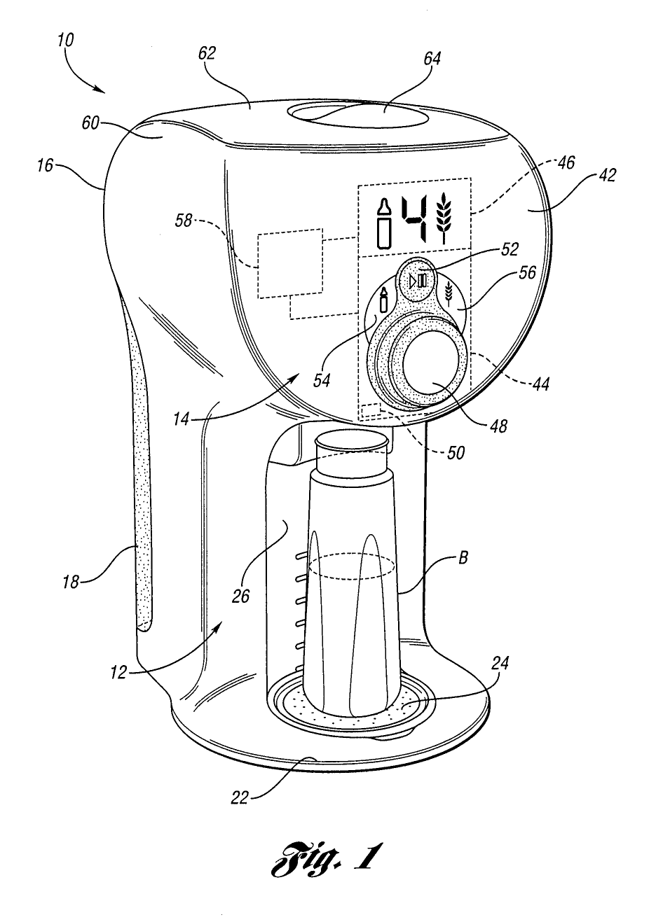

FIG. 1 illustrates an embodiment of a baby food preparation apparatus, indicated generally by reference numeral 10. Apparatus 10 is configured for holding water and dry baby food, such as formula and/or cereal, for mixing and dispensing. Apparatus 10 allows a user to quickly prepare such baby food with no mess or measuring.

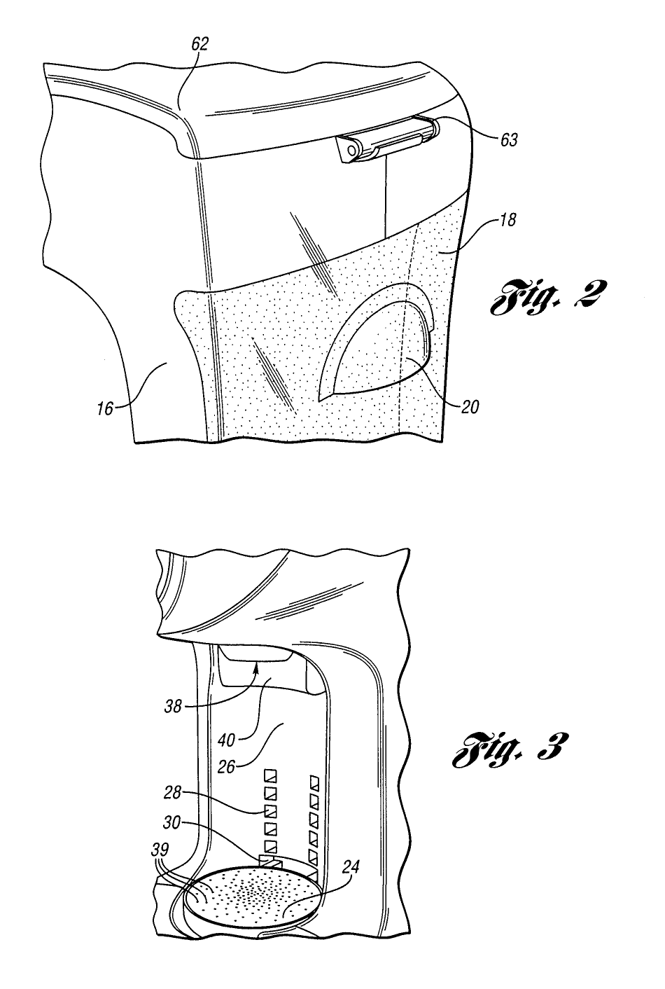

Apparatus 10 includes a housing 12 having a front portion 14 for user interaction, dispensing of dry baby food and water, and for receiving a container, such as a baby bottle B, into which the food and water are dispensed. A rear portion 16 of the housing 12 receives a removable water tank 18 which may be filled by a user with either tap or bottled water. Of course, the water tank 18 may alternatively be located along another area, such as a side portion, of the housing 12. As best shown in FIG. 2, the water tank 18 may include an integrated handle 20 for easy removal from the housing 12 and carrying. In one embodiment, the water tank 18 may hold up to 2 liters of water, but may be designed with any suitable volume. The water tank 18 may have graduation lines to indicate the volume of water contained in the tank 18. The water tank 18 is shown as sliding into the housing 12, and in alternative embodiments it may clip into or be received into a recessed step of the housing 12.

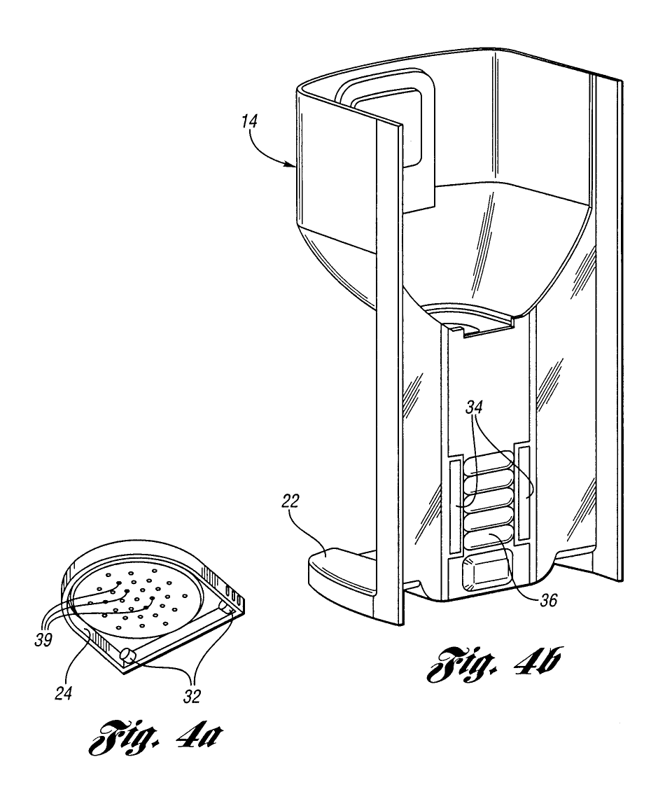

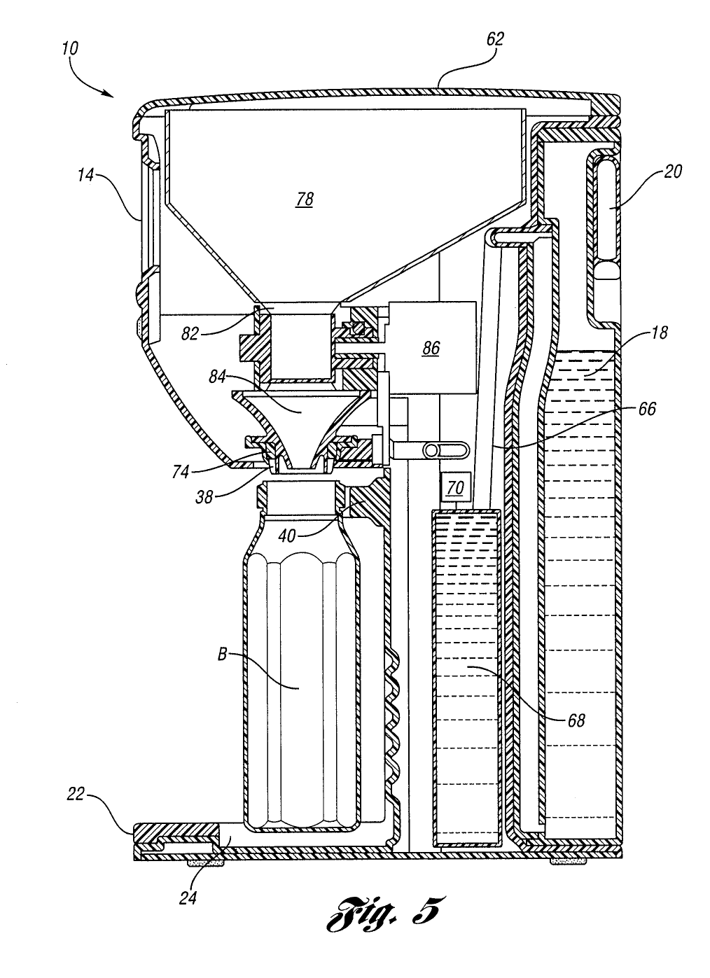

Referring again to FIG. 1, the housing front portion 14 includes a base 22 which receives an adjustable platform 24 for supporting a baby bottle B to be filled. In one embodiment depicted in FIG. 3, front portion 14 includes a recessed area 26 having slots 28 for receiving corresponding tabs 30 on the platform 24, such that the platform 24 may be disposed at a plurality of different heights to adjust for short and tall container sizes. In one example, the platform 24 may be positioned at the lowest height for filling an 8 ounce bottle and positioned at the highest height for filling a 2 ounce bottle. FIGS. 4a and 4b illustrate another embodiment of an adjustable support platform 24 wherein the platform 24 may be removably secured to the recessed area 26 of the housing 12 by magnetic force, such as between magnets 32 on the platform 24 and corresponding magnets or metallic strips 34 on an interior of the housing 12. A series of indentations 36 extending horizontally between the strips 34 can be provided to help the user locate the proper height for the baby bottle B to be placed underneath a dispensing portion 38, as described further below. The series of indentations 36 may also interact with the platform 24 to help structurally support the platform 24, a bottle B and any contents therein during use of the apparatus 10. The upper lip or neck of the bottle B or other container may rest against a locating member 40 to assist in positioning the mouth of the bottle B below the dispensing portion 38. The platform 24 may have a series of apertures 39 on the surface of the platform 24 to permit any spilled liquids to flow through the apertures 39 and to a holding area below or within the platform 24.

As shown in FIG. 1, front housing portion 14 of the apparatus 10 includes a front face 42 having a user interface 44 and a display 46, such as an LCD (liquid crystal display) or LED (light emitting diode) display. The user interface 44 includes a selector knob 48 for dispensing an amount of dry baby food such as formula or cereal, a power button 50, a start button 52 and, in one embodiment, a formula button 54 and a cereal button 56. Advantageously, the apparatus 10 may be used to select for the preparation of either formula or cereal, and selection of the corresponding button 54, 56 will determine the appropriate amount of water to be dispensed for the selected food. A processor 58, such as a controller, is provided in communication with the components of the user interface 44 and the display 46, and it is contemplated that the user interface 44 may provide for both manual and programmable operation of the preparation apparatus 10.

A top portion 60 of the housing 12 includes a lid 62 which is pivotably or removably attached to the housing 12, such as by hinge 63. The lid 62 may include a handle 64 and, when opened, exposes a reservoir for dry baby food as will be described below.

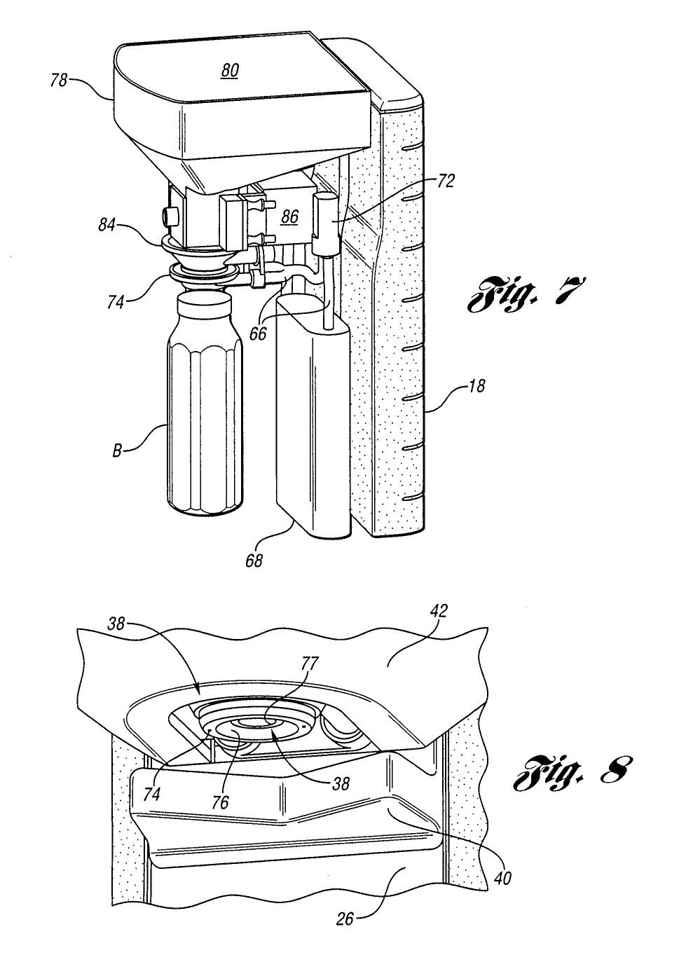

FIGS. 5-7 illustrate several internal components of an embodiment of the baby food preparation apparatus 10. The water tank 18 is in fluid communication via tubing 66 with a reserve water tank 68 provided within the housing 10. The reserve water tank 68 may be used to heat the water to the appropriate temperature prior to dispensing. In one embodiment, the reserve water tank 68 may function similar to an automated coffee pot, wherein the reserve water tank 68 includes water heated to specification that is used initially and continuously fed by the water in the removable water tank 18. In that way, water is heated and ready on demand, wherein heating may be accomplished by a heater 70 in communication with the processor 58 and/or user interface 44. The heater 70 may be a resistive heater or other heater as is known in the art. When the power button 50 is pressed, power is provided to the preparation apparatus 10 by a power source (not shown), such as a wall outlet or battery. When the heater 70 receives power, the water in the reserve water tank 68 is heated. In one embodiment, the water is not boiled, but rather is heated to 98 degrees F. or another designated temperature. Alternatively, the mixture of water and formula may be heated after mixing in the container by providing a heating unit (not shown) within the base 22.

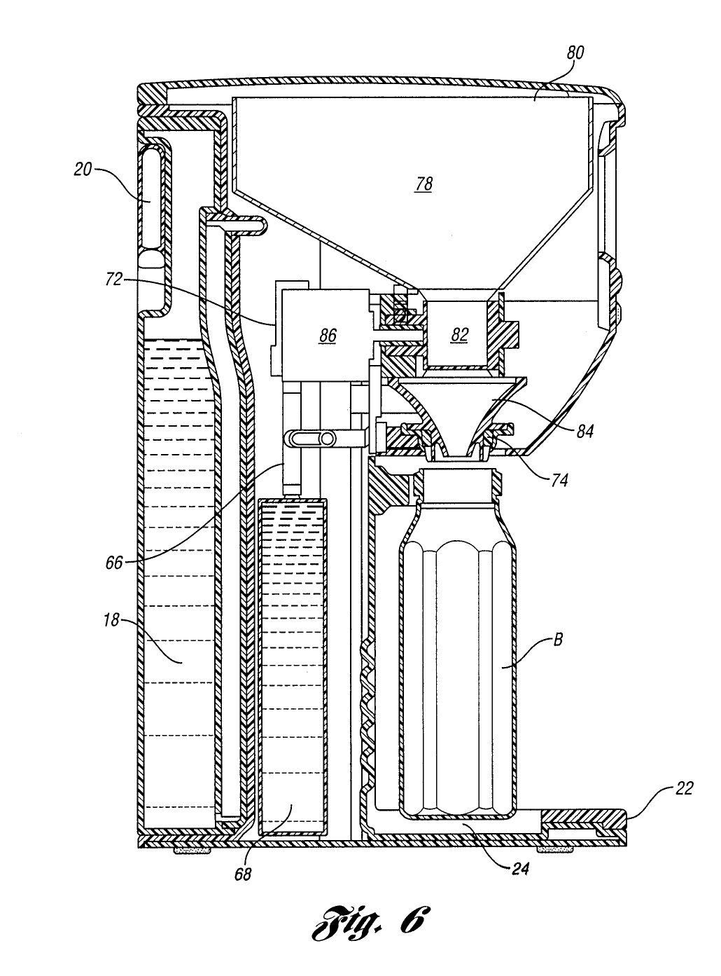

From the reserve water tank 68, water is moved through tubing 66 into the dispensing portion 38, such as by a pump 72 (see FIG. 6). The preparation apparatus 10 includes separate dry baby food and water dispensing pathways within the dispensing portion 38. In one non-limiting embodiment, the water pathway 76 encircles the dry baby food pathway 77, such as in the form of an annular member 74 as shown in FIGS. 5-8. The annular member 74 may include a plurality of openings for dispensing water into the container, which surround a central opening 77 for the dry food. In one embodiment, water may be dispensed from the dispensing portion 38 at a programmed rate through cooperation with the processor 58 and the user interface 44.

With reference to FIGS. 5-10, a reservoir 78 or hopper is provided within the housing 12 for holding dry baby food, such as formula or cereal. In one embodiment, the reservoir 78 is sized to hold approximately 24 ounces of powdered formula, which is a standard container amount provided for retail sale, but the reservoir 78 may be constructed to have any suitable volume. The reservoir 78 has a relatively wide upper portion 80 which narrows to a lower neck 82 through which dry baby food is released, such as gravity fed, into a funnel 84 within the housing 10, as best shown in FIGS. 5-6. Additionally, a vibratory motor 86 for creating a vibration action to shake and sift the dry baby food while dispensing may be provided. In the embodiment depicted herein, the annular member 74 encircles the funnel 84, such that separate pathways for dispensing water and dry baby food are provided. Of course, other configurations of water and dry baby food pathways within the dispensing portion 38 other than those described herein are also contemplated.

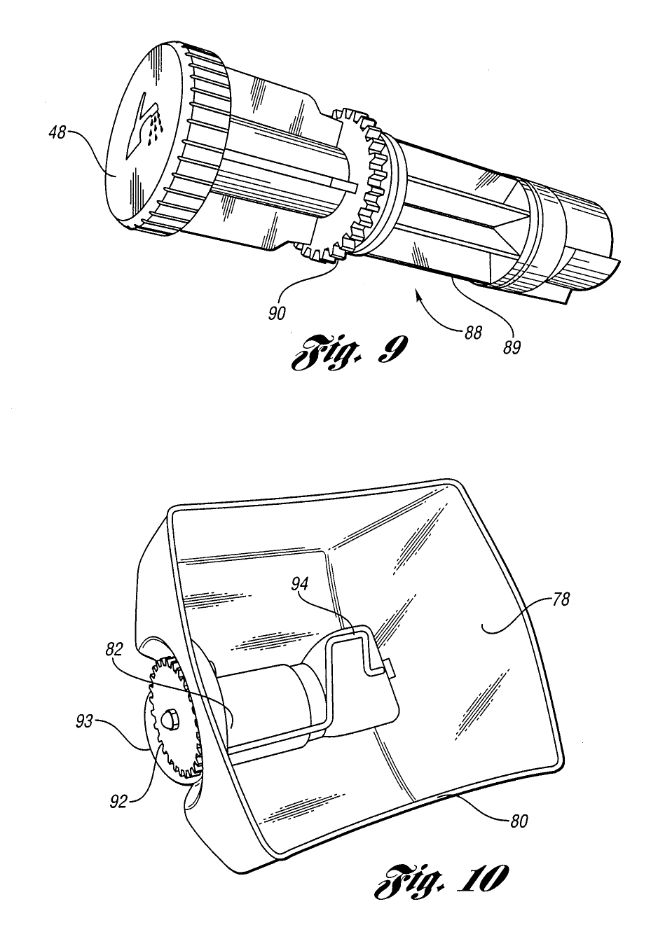

As shown in FIGS. 9-10, the selector knob 48 is the user end of a dispensing mechanism 88 for the dry baby food. In one embodiment, the dispensing mechanism 88 is generally cylindrical and configured to be received within a corresponding aperture 93 in the reservoir 78 so as to extend at least partially therethrough disposed between the upper portion 80 and the neck 82. The dispensing mechanism 88 includes a plurality of circumferentially extending blades 89 which, in one embodiment, are spaced and sized to each contain an amount of dry baby food necessary for creating a 1 ounce serving size of prepared food. As described above, it will be appreciated that a quarter turn of the selector knob 48 then results in a portion being dispensed suitable for preparing a 2 ounce serving size. The dispensing mechanism 88 may include a first gear 90 which engages a second gear 92 rotatably attached to the reservoir 78 when the dispensing mechanism 88 is disposed within the reservoir 78. An agitator 94 may be connected to the second gear 92, such that rotation of the selector knob 48 and thus rotation of the first gear 90 results in rotation of the second gear 92 and the agitator 94 for mixing the dry baby food and moving it toward the funnel 84. In one embodiment, the dispensing mechanism 88 is removable from the housing 12, such as for cleaning

In operation, a user fills the water tank 18 with water and fills the reservoir 78 with a dry baby food, such as powdered formula or instant cereal. A container, such as a baby bottle B, is placed on the adjustable platform 24 underneath the dispensing portion 38. The user turns on the apparatus 10 by pressing the power button 50. In one embodiment, the power button 50 may include a light that will then illuminate and the display 46 will indicate “0”. The user will select to prepare formula or cereal by pressing the formula button 54 or the cereal button 56, and the appropriate icon will illuminate on the display 46.

The user then designates the amount of prepared formula or cereal desired through the user interface 44 through rotation of the selector knob 48. In one embodiment, the dry baby food is dispensed in 2 ounce increments of prepared food, wherein one quarter (i.e., 90 degree) turn of the selector knob 48 dispenses each increment equivalent to a 2 ounce serving, and the display 46 will display a number corresponding to the serving size dispensed. Of course, other serving amounts or various rotations of the selector knob 48 are also contemplated for use with the apparatus 10. The user then presses the start button 52, and in one embodiment the power button 50 may flash a color, such as red while the water is heated and dispensed through the dispensing portion 38. It is contemplated that the start button 52 may be depressed again should the user desire to pause the dispensing of water for any reason.

Based upon the formula or cereal selection and the serving size, the apparatus 10 will automatically dispense the correct amount of warmed water at an appropriate feeding temperature. The processor 58 receives inputs from the formula button 54 or the cereal button 56, which indicate a designated dry food to water ratio. The processor 58 also receives inputs from the selector knob 48 or other user input which provide information regarding the amount of food to be prepared such that the appropriate amount of water is dispensed with the dry food.

It is understood that the dry baby food may be dispensed through the dispensing portion 38 in a serial fashion as described above, or may alternatively be dispensed simultaneously. When the water has finished dispensing, the power button 50 may flash a different color, such as green. The user may then place a lid, such as a cap or nipple, atop the bottle B or other container to seal it and may shake the sealed bottle B to ensure complete mixture of the water with the formula or other dry baby food before serving.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A baby food preparation apparatus, comprising:
a housing having a dispensing portion for dispensing dry baby food and water;
a reservoir within the housing configured to hold dry baby food and dispense the dry baby food through the dispensing portion;
a water tank removably received within the housing configured to hold water and dispense the water through the dispensing portion;
a user interface provided on the housing, the user interface having a selector knob for selecting a desired serving size of prepared baby food, and selector buttons for selecting a type of baby food to be prepared; and
a processor in communication with the user interface and configured to dispense an amount of water corresponding to the type of baby food selected and the desired serving size.

2. A baby food preparation apparatus, comprising:
a housing having a dispensing portion for dispensing dry baby food and water;
a reservoir within the housing configured to hold dry baby food and dispense the dry baby food through the dispensing portion, the reservoir including a reservoir gear rotatably attached thereto and an agitator connected to the reservoir gear;
a water tank removably received within the housing configured to hold water and dispense the water through the dispensing portion;
a generally cylindrical dispensing mechanism removably received in the housing and extending at least partially through the reservoir, the dispensing mechanism having a selector knob at one thereof accessible by a user at a user interface of the housing for selecting a desired serving size of prepared baby food, the dispensing mechanism having a plurality of circumferentially extending blades spaced and sized to hold increments of dry baby food to be dispensed corresponding to the desired serving size, the dispensing mechanism having a first gear disposed thereon arranged to engage the reservoir gear such that rotation of the selector knob rotates the agitator to mix the dry baby food for dispensing; and
a processor in communication with the user interface and configured to dispense an amount of water corresponding to the desired serving size.

3. A baby food preparation apparatus, comprising:
a housing having a dispensing portion for dispensing dry baby food and water, the dispensing portion having an annular water pathway separate from and encircling a central dry food pathway;
a reservoir within the housing configured to hold dry baby food and dispense the dry baby food through the dry food pathway of the dispensing portion;
a water tank removably received within the housing configured to hold water and dispense the water through the water pathway of the dispensing portion;
an adjustable platform received on the housing for supporting a container at a designated height with respect to the dispensing portion;
a user interface provided on the housing, the user interface having a selector knob for selecting a desired serving size of prepared baby food; and
a processor in communication with the user interface configured to dispense an amount of water corresponding to the desired serving size.
